(19) United States
(12) Patent Application Publication
(10) Pub. No.: US 2020/0006945 A1
(43) Pub. Date: Jan. 2, 2020

(54) Anti-Islanding Systems and Methods Using Harmonics Injected in a Rotation Opposite the Natural Rotation

(71) Applicant: Ideal Power Inc., Austin, TX (US)

(72) Inventors: Nicholas A. Lemberg, Austin, TX (US); Guy Michael Barron, Austin, US (US)

(73) Assignee: Ideal Power Inc., Austin, TX (US)

(21) Appl. No.: 16/439,461

(22) Filed: Jun. 12, 2019

Related U.S. Application Data
(63) Continuation of application No. PCT/US2017/067143, filed on Dec. 18, 2017.
(60) Provisional application No. 62/440,331, filed on Dec. 29, 2016.
(60) Provisional application No. 62/435,469, filed on Dec. 16, 2016.

(51) Int. Cl. H02J 3/38; H02M 3/335

(52) U.S. Cl. CPC H02J 3/383; H02J 2003/388; H02M 3/33507

(57) ABSTRACT

An active anti-islanding architecture where a power converter injects a current component at a harmonic of the fundamental power frequency is injected with a phase sequence opposite to that which normally be present with that harmonic. (For example, a 5^{th} harmonic frequency can be used with a positive phase sequence, or a 7^{th} harmonic frequency with a negative phase sequence.) The injected current component can have a thousandth or less of the power transferred by the converter, since the distinctive phase sequence of the injected signal facilitates recognition of a corresponding term in the observed voltage.

### CROSS-REFERENCE

Priority is claimed from U.S. provisional application 62/435,469, all of which is hereby incorporated by reference. Priority is also claimed from 62/440,331, all of which is also hereby incorporated by reference.

### BACKGROUND

The present application relates to systems which include local power sources, and more particularly to detection of “islanding,” when a local power domain is not directly connected to the power grid.

Note that the points discussed below may reflect the hindsight gained from the disclosed inventions, and are not necessarily admitted to be prior art.

### What is Islanding

Islanding is the condition in which a distributed generator (DG) continues to power a location even though electrical grid power is no longer present. Islanding can be dangerous to utility workers, who may not realize that a circuit is still powered, and it may prevent automatic re-connection of devices. Additionally, without strict frequency control the balance between load and generation in the islanded circuit is going to be violated, leading to abnormal frequencies and voltages. For those reasons, distributed generators must detect islanding and immediately disconnect from the circuit; this is referred to as anti-islanding.

Electrical inverters are devices that convert direct current (DC) to alternating current (AC). Grid-interactive inverters have the additional requirement that they produce AC power that matches the existing power presented on the grid. In particular, a grid-interactive inverter must match the voltage, frequency and phase of the power line it connects to. There are numerous technical requirements to the accuracy of this tracking.

Consider the case of a house with an array of solar panels on the roof. Inverter(s) attached to the panels convert the varying DC current provided by the panels into AC power that matches the grid supply. If the grid is disconnected, the voltage on the grid line might be expected to drop to zero, a clear indication of a service interruption. However, consider the case when the house's load exactly matches the output of the panels at the instant of the grid interruption. In this case the panels can continue supplying power, which is used up by the house's load. In this case there is no obvious indication that an interruption has occurred.

Normally, even when the load and production are exactly matched (the so-called “balanced condition”), the failure of the grid will result in several additional transient signals being generated. For instance, there will almost always be a brief decrease in line voltage, which will signal a potential fault condition. However, such events can also be caused by normal operation, like the starting of a large electric motor.

A common example of islanding is a distribution feeder that has solar panels attached to it. In the case of a power outage, the solar panels will continue to deliver power as long as irradiance is sufficient. In this case, the circuit detached by the outage becomes an “island”. For this reason, solar inverters that are designed to supply power to the grid are generally required to have some sort of automatic anti-islanding circuitry.

Some designs, commonly known as a microgrid, allow for intentional islanding. In case of an outage, the microgrid controller disconnects the local circuit from the grid on a dedicated switch and forces the distributed generator(s) to power the entire local load.

Islanding is a rare event but is viewed as a significant safety risk, since service workers or emergency responders may be in the area servicing what is perceived to be non-energized circuits and inadvertently be exposed to active wiring.

### What is Anti-Islanding

Anti-Islanding is a protective measure required of power converters to prevent unintentional islanded operation.

Methods to detect islanding without a large number of false positives are the subject of considerable research. Each method has some threshold that needs to be crossed before a condition is considered to be a signal of grid interruption, which leads to a “non-detection zone” (NDZ), the range of conditions where a real grid failure will be filtered out.

In general, these can be classified into passive methods, which look for transient events on the grid, and active methods, which probe the grid by sending signals of some sort from the inverter or the grid distribution point. There are also methods that the utility can use to detect the conditions that would cause the inverter-based methods to fail, and deliberately upset those conditions in order to make the inverters switch off. Some of these methods are summarized below.

### Passive Methods

Passive methods include any system that attempts to detect transient changes on the grid, and use that information as the basis as a probabilistic determination of whether or not the grid has failed, or some other condition has resulted in a temporary change.

Under/Over Voltage

According to Ohm's law, the voltage in an electrical circuit is a function of electric current (the supply of electrons) and the applied load (resistance). In the case of a grid interruption, the current being supplied by the local source is unlikely to match the load so perfectly as to be able to maintain a constant voltage. A system that periodically samples voltage and looks for sudden changes can be used to detect a fault condition.

Under/over voltage detection is normally trivial to implement in grid-interactive inverters, because the basic function of the inverter is to match the grid conditions, including voltage. That means that all grid-interactive inverters, by necessity, have the circuitry needed to detect the changes. All that is needed is an algorithm to detect sudden changes. However, sudden changes in voltage are a common occurrence on the grid as loads are attached and removed, so a threshold must be used to avoid false disconnections. The range of conditions that result in non-detection with this method may be large, and these systems are generally used along with other detection systems.

Under/Over Frequency

The frequency of the power being delivered to the grid is a function of the supply, one that the inverters carefully match. When the grid source is lost, the frequency of the power would fall to the natural resonant frequency of the circuits in the island. Looking for changes in this frequency, like voltage, is easy to implement using already required functionality, and for this reason almost all inverters also look for fault conditions using this method as well.

Unlike changes in voltage, it is generally considered highly unlikely that a random circuit would naturally have a natural frequency the same as the grid power. However, many devices deliberately synchronize to the grid frequency, like televisions. Motors, in particular, may be able to provide a signal that is within the NDZ for some time as they “wind down”. The combination of voltage and frequency shifts still results in a NDZ that is not considered adequate by all.[17]

Rate of Change of Frequency

In order to decrease the time in which an island is detected, rate of change of frequency has been adopted as a detection method. Should the rate of change of frequency (or “ROCOF” value) be greater than a certain value, the embedded generation will be disconnected from the network.

Voltage Phase Jump Detection

Loads generally have power factors that are not perfect, meaning that they do not accept the voltage from the grid perfectly, but impede it slightly. Grid-tie inverters, by definition, have power factors of 1. This can lead to changes in phase when the grid fails, which can be used to detect islanding.

Inverters generally track the phase of the grid signal using a phase locked loop (PLL) of some sort. The PLL stays in sync with the grid signal by tracking when the signal crosses zero volts. Between those events, the system is essentially “drawing” a sine-shaped output, varying the current output to the circuit to produce the proper voltage waveform. When the grid disconnects, the power factor suddenly changes from the grid's (1) to the load's (˜1). As the circuit is still providing a current that would produce a smooth voltage output given the known loads, this condition will result in a sudden change in voltage. By the time the waveform is completed and returns to zero, the signal will be out of phase.

The main advantage to this approach is that the shift in phase will occur even if the load exactly matches the supply in terms of Ohm's law—the NDZ is based on power factors of the island, which are very rarely 1. The downside is that many common events, like motors starting, also cause phase jumps as new impedances are added to the circuit. This forces the system to use relatively large thresholds, reducing its effectiveness.

Harmonics Detection

Even with noisy sources, like motors, the total harmonic distortion (THD) of a grid-connected circuit is generally unmeasurable due to the essentially infinite capacity of the grid that filters these events out. Inverters, on the other hand, generally have much larger distortions, as much as 5% THD. This is a function of their construction; some THD is a natural side-effect of the switched-mode power supply circuits most inverters are based on.

Thus, when the grid disconnects, the THD of the local circuit will naturally increase to that of the inverters themselves. This provides a very secure method of detecting islanding, because there are generally no other sources of THD that would match that of the inverter. Additionally, interactions within the inverters themselves, notably the transformers, have non-linear effects that produce unique 2nd and 3rd harmonics that are easily measurable.

The drawback of this approach is that some loads may filter out the distortion, in the same way that the inverter attempts to. If this filtering effect is strong enough, it may reduce the THD below the threshold needed to trigger detection. Systems without a transformer on the “inside” of the disconnect point will make detection more difficult. However, the largest problem is that modern inverters attempt to lower the THD as much as possible, in some cases to unmeasurable limits.

### Active Methods

Active methods generally attempt to detect a grid failure by injecting small signals into the line, and then detecting whether or not the signal changes.

Negative-Sequence Current Injection

This method is an active islanding detection method which can be used by three-phase electronically coupled distributed generation (DG) units. The method is based on injecting a negative-sequence current through the voltage-sourced converter (VSC) controller and detecting and quantifying the corresponding negative-sequence voltage at the point of common coupling (PCC) of the VSC by means of a unified three-phase signal processor (UTSP). The UTSP system is an enhanced phase-locked loop (PLL) which provides a high degree of immunity to noise, and thus enables islanding detection based on injecting a small negative-sequence current. The negative-sequence current is injected by a negative-sequence controller which is adopted as the complementary of the conventional VSC current controller. The negative-sequence current injection method detects an islanding event within 60 ms (3.5 cycles) under UL1741 test conditions, requires 2% to 3% negative-sequence current injection for islanding detection, can correctly detect an islanding event for the grid short circuit ratio of 2 or higher, and is insensitive to variations of the load parameters of UL1741 test system.

Impedance Measurement

Impedance Measurement attempts to measure the overall impedance of the circuit being fed by the inverter. It does this by slightly “forcing” the current amplitude through the AC cycle, presenting too much current at a given time. Normally this would have no effect on the measured voltage, as the grid is an effectively infinitely stiff voltage source. In the event of a disconnection, even the small forcing would result in a noticeable change in voltage, allowing detection of the island.

The main advantage of this method is that it has a vanishingly small NDZ for any given single inverter. However, the inverse is also the main weakness of this method; in the case of multiple inverters, each one would be forcing a slightly different signal into the line, hiding the effects on any one inverter. It is possible to address this problem by communication between the inverters to ensure they all force on the same schedule, but in a non-homogeneous install (multiple installations on a single branch) this becomes difficult or impossible in practice. Additionally, the method only works if the grid is effectively infinite, and in practice many real-world grid connections do not sufficiently meet this criterion.

Impedance Measurement at a Specific Frequency

Although the methodology is similar to Impedance Measurement, this method, also known as “harmonic amplitude jump”, is actually closer to Harmonics Detection. In this case, the inverter deliberately introduces harmonics at a given frequency, and as in the case of Impedance Measurement, expects the signal from the grid to overwhelm it until the grid fails. Like Harmonics Detection, the signal may be filtered out by real-world circuits.

Slip Mode Frequency Shift

This is one of the newest methods of islanding detection, and in theory, one of the best. It is based on forcing the phase of the inverter's output to be slightly mis-aligned with the grid, with the expectation that the grid will overwhelm this signal. The system relies on the actions of a finely tuned phase-locked loop to become unstable when the grid signal is missing; in this case, the PLL attempts to adjust the signal back to itself, which is tuned to continue to drift. In the case of grid failure, the system will quickly drift away from the design frequency, eventually causing the inverter to shut down.

The major advantage of this approach is that it can be implemented using circuitry that is already present in the inverter. The main disadvantage is that it requires the inverter to always be slightly out of time with the grid, a lowered power factor. Generally speaking, the system has a vanishingly small NDZ and will quickly disconnect, but it is known that there are some loads that will react to offset the detection.

Frequency Bias

Frequency bias forces a slightly off-frequency signal into the grid, but “fixes” this at the end of every cycle by jumping back into phase when the voltage passes zero. This creates a signal similar to Slip Mode, but the power factor remains closer to that of the grid's, and resets itself every cycle. Moreover, the signal is less likely to be filtered out by known loads. The main disadvantage is that every inverter would have to agree to shift the signal back to zero at the same point on the cycle, say as the voltage crosses back to zero, otherwise different inverters will force the signal in different directions and filter it out.

There are numerous possible variations to this basic scheme. The Frequency Jump version, also known as the “zebra method”, inserts forcing only on a specific number of cycles in a set pattern. This dramatically reduces the chance that external circuits may filter the signal out. This advantage disappears with multiple inverters, unless some way of synchronizing the patterns is used.

### Harmonics in Power Systems

Harmonics often occur in power systems as a consequence of non-linear loads. Each order of harmonics contributes to different sequence components. Harmonics of order 2n make no contribution. Harmonics of order 3+6n contribute to the zero sequence. Harmonics of order 5+6n contribute to the negative sequence. Harmonics of order 7+6n contribute to the positive sequence. For example, the 5th harmonic is normally a negative sequence harmonic, while the 7th is a positive sequence harmonic.

### Anti-Islanding Systems and Methods Using Harmonics Injected in a Rotation Opposite the Natural Rotation

The present application describes a new architecture for active island detection; the method described here relies on signal injection and detection of signal injection. The injection is preferably performed by a power converter in which instantaneous changes can be made to the current drive; in such a system, a special signal is injected to detect islanding. If the power converter is connected to the power grid, this special signal will be absorbed by the near-zero impedance of the power grid; however, if the power grid is not connected to the power converter, the special signal will be present at a much higher magnitude. When this condition is detected, alarm or shutdown routines can then be initiated.

The disclosed Anti-Islanding Methods and systems use injection of current at a harmonic of the fundamental, with a sequence which corresponds to the REVERSE of the normal phase sequence. Thus, a 5th harmonic would normally be a “negative sequence” signal, but the preferred methods inject 5^{th} harmonic current with a positive sequence. This distinction allows the presence or absence of a voltage component driven by the injected signal to be more easily detected in an electrically noisy environment.

The anti-islanding signal is created based on the fundamental operating frequency of the converter and the scaling factor used for threshold detection.

The anti-islanding signal is then added to the fundamental current output command.

The aggregated command is then synthesized by the power converter at its output terminals.

Detection of the signal is preferably done through the voltage sensing mechanism of the power converter, together with signal decomposition. The decomposed signal is then compared to detection threshold, and determination is made based on threshold comparison results.

Note that the preferred anti-islanding method injects a signal as a current, and detects that signal (if not dissipated into the grid) as a voltage.

### BRIEF DESCRIPTION OF THE DRAWINGS

The disclosed inventions will be described with reference to the accompanying drawings, which show important sample embodiments and which are incorporated in the specification hereof by reference, wherein:

FIG. 1 schematically shows how the injected signal component is detected (if not being absorbed by the power grid).

FIG. 2 shows how a distinctive signal, with a distinctive phase sequence, is injected at the output of component is detected (if not being absorbed by the power grid).

FIG. 3A shows a diagram of unmodified 3-phase power waveforms, and FIG. 3B shows an example of a converter output in which a small component of antisense harmonic has been added into the output of the power converter.

FIG. 4 shows an example of a power-packet-switching power converter.

### DETAILED DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

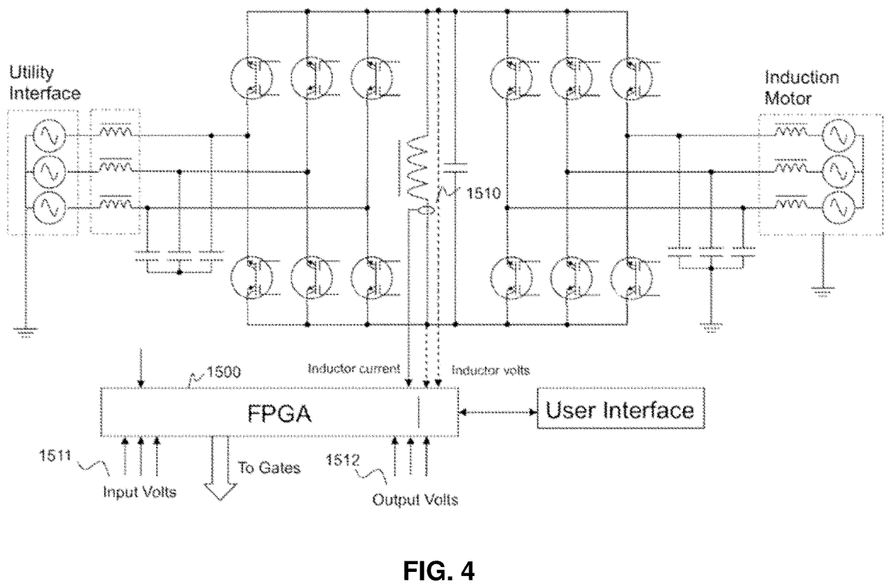

FIG. 4 shows an example of a power-packet-switching power converter. This architecture is described in detail in U.S. Pat. No. 9,042,131, and various modifications and alternatives are shown and described in various other patents and applications of the present application. This is contemplated as an especially advantageous architecture for implementing the disclosed innovations, but other architectures may also be useful. In this architecture power is transferred through the link inductor, and output currents are driven onto the various output nodes by appropriately switching the bidirectional switches in each of the phase legs.

The present application describes a new architecture for active island detection; the method described here relies on injection and detection of a distinctive multi-phase signal which has a reversed phase sequence.

The injection is preferably performed by a power converter (such as a power-packet-switching-architecture converter) in which instantaneous changes can be made to the current drive; in such a system, a special signal is injected to detect islanding. If the power converter is connected to the power grid, this special signal will be absorbed by the near-zero impedance of the power grid; however, if the power grid is not connected to the power converter, the special signal will be present at a much higher magnitude. When this condition is detected, alarm or shutdown routines can then be initiated.

The disclosed Anti-Islanding Methods and systems use injection of current at a harmonic of the fundamental, with a sequence which corresponds to the REVERSE of the normal phase sequence. Thus, a 5th harmonic would normally be a “negative sequence” signal, but the preferred methods inject 5^{th} harmonic current with a positive sequence. This distinction allows the presence or absence of a voltage component driven by the injected signal to be more easily detected in an electrically noisy environment.

The anti-islanding signal is created based on the fundamental operating frequency of the converter and the scaling factor used for threshold detection. The anti-islanding signal is then added to the fundamental current output command. The aggregated command is then synthesized by the power converter at its output terminals.

Detection of the signal is preferably done through the voltage sensing mechanism of the power converter, together with signal decomposition. The decomposed signal is then compared to detection threshold, and determination is made based on threshold comparison results.

Note that the preferred anti-islanding method injects a signal as a current, and detects that signal (if not dissipated into the grid) as a voltage.

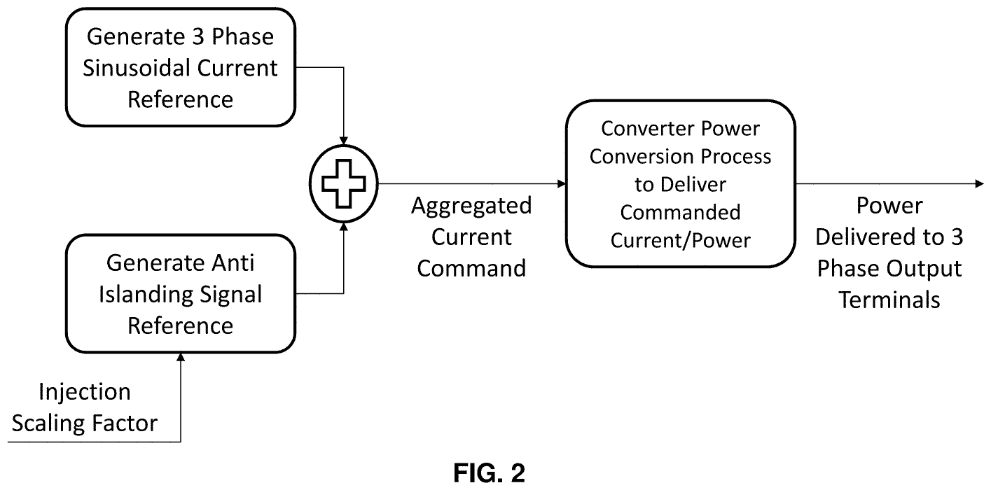

FIG. 2 shows how a distinctive additional current component is injected by the power converter. This is preferably a harmonic with a reversed phase sequence.

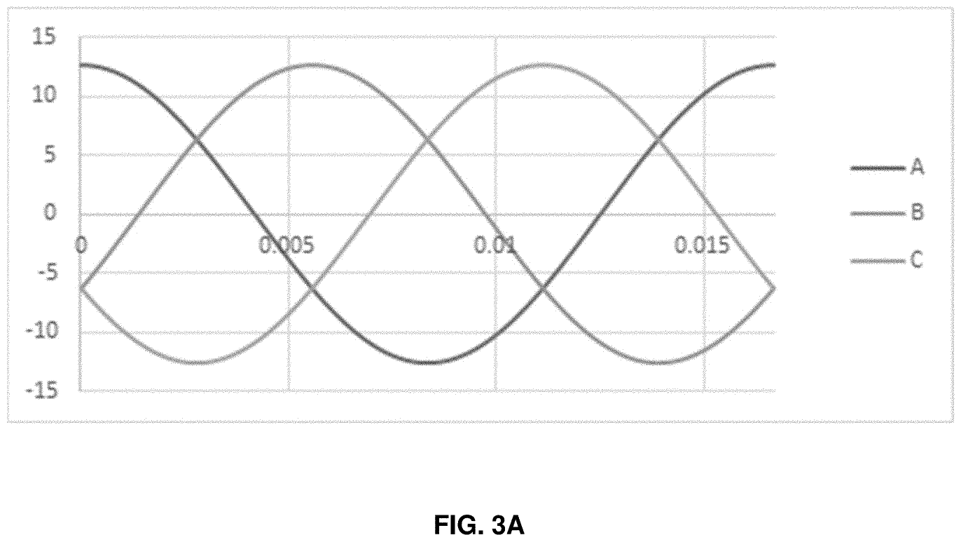

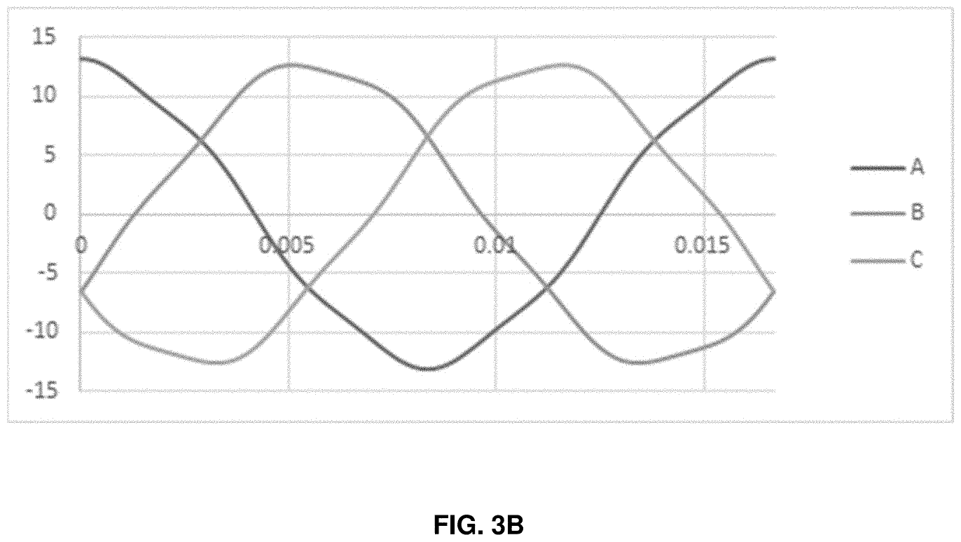

FIG. 3A shows a diagram of unmodified 3-phase power waveforms, and FIG. 3B shows an example of a converter output in which a small component of antisense harmonic has been added into the output of the power converter.

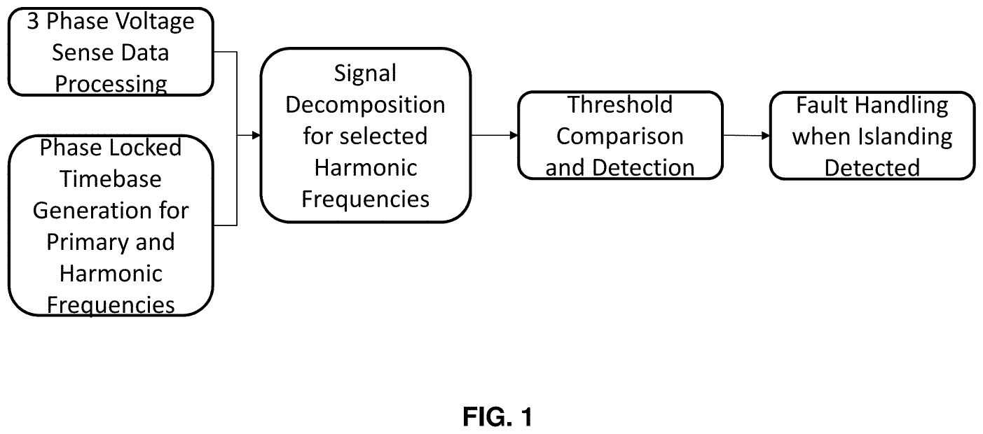

FIG. 1 schematically shows how the injected signal component is detected (if not being absorbed by the power grid). When the injected signal component is found to be above threshold, an islanding condition is indicated, which can lead to responses as the higher-level control logic may indicate. In the simplest example, the power converter simply shuts down when islanding is detected.

### Advantages

The disclosed innovations, in various embodiments, provide one or more of at least the following advantages. However, not all of these advantages result from every one of the innovations disclosed, and this list of advantages does not limit the various claimed inventions.

The disclosed architecture provides a robust detection mechanism for unintentional islanded operation.

The disclosed architecture works in harmonic rich environments.

By using an out of sequence harmonic the method can operate in environments with large harmonic content as harmonics by nature follow a specific rotation sequence. Working with an out of sequence harmonic creates a clean slate for both signal injection and detection free from outside interference.

The disclosed architecture does not interfere with fundamental frequency.

Use of a harmonic in place of fundamental frequency injection ensures that the fundamental frequency and waveform remains undisturbed. This is quite different from frequency modulation techniques, and from techniques that inject negative sequence fundamentals.

The disclosed architecture can detect islanding throughout the fundamental cycle.

Many competing methods rely on zero crossing perturbations. By contrast, by using the waveform directly, detection can take place at any point during the fundamental cycle, not just at zero crossing.

The disclosed architecture provides improved safety in power conversion systems.

The disclosed architecture provides power conversion systems with better complicance with utility system requirements.

The disclosed architecture provides advantages can be realized in distributed power architectures, including microgrids and systems with cogeneration.

According to some but not necessarily all embodiments, there is provided: A method of anti-islanding, comprising the actions of: a) converting power to provide, at output terminals, a multi-phase AC current at a predetermined base frequency, while also b) adding in a current component, on the output terminals, at the nth harmonic of the predetermined base frequency, with a distinctive phase sequence which is different from that normally present in the nth harmonic; c) testing whether a voltage corresponding to said nth harmonic and said distinctive phase sequence exceeds a threshold value on the output terminals, and, if so, detecting an islanding condition.

According to some but not necessarily all embodiments, there is provided: A system, comprising: a) at least one local power source; b) at least one power converter, connected to draw power from the local power source and to drive power onto multiple phase lines of a power bus which is at least sometimes connected to a utility power grid; wherein the power converter also operates to add in a current component, on the output terminals, at the nth harmonic of the predetermined base frequency, with a distinctive phase sequence which is different from that normally present in the nth harmonic; and c) control circuitry which monitors the voltage on the multiple phase lines of the power bus, and controls the operation of the power converter accordingly; while also testing whether a voltage corresponding to said nth harmonic and said distinctive phase sequence exceeds a threshold value on the output terminals, and, if so, indicating an islanding condition.

Modifications and Variations

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

For example, while the primary preferred embodiment uses 5^{th} harmonic injection with positive phase sequence (opposite to that normally found in a fifth harmonic), one contemplated alternative uses 7^{th} harmonic injection with negative phase sequence (opposite to that normally found in a seventh harmonic).

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

Those of ordinary skill in the relevant fields of art will recognize that other inventive concepts may also be directly or inferentially disclosed in the foregoing. NO inventions are disclaimed.

The claims as filed are intended to be as comprehensive as possible, and NO subject matter is intentionally relinquished, dedicated, or abandoned.

1. A method of anti-islanding, comprising the actions of:
a) converting power to provide, at output terminals, a multi-phase AC current at a predetermined base frequency, while also
b) adding in a current component, on the output terminals, at the nth harmonic of the predetermined base frequency, with a distinctive phase sequence which is different from that normally present in the nth harmonic;
c) testing whether a voltage corresponding to said nth harmonic and said distinctive phase sequence exceeds a threshold value on the output terminals, and, if so, detecting an islanding condition.

2. The method of claim 1, wherein the nth harmonic is the 5th harmonic, and the distinctive phase sequence is a positive phase sequence.

3. The method of claim 1, wherein the nth harmonic is the 7th harmonic, and the distinctive phase sequence is a negative phase sequence.

4. The method of claim 1, wherein the converting and adding steps are performed by a power-packet switching converter.

5. A system, comprising:
a) at least one local power source;
b) at least one power converter, connected to draw power from the local power source and to drive power onto multiple phase lines of a power bus which is at least sometimes connected to a utility power grid; wherein the power converter also operates to add in a current component, on the output terminals, at the nth harmonic of the predetermined base frequency, with a distinctive phase sequence which is different from that normally present in the nth harmonic; and
c) control circuitry which monitors the voltage on the multiple phase lines of the power bus, and controls the operation of the power converter accordingly; while also testing whether a voltage corresponding to said nth harmonic and said distinctive phase sequence exceeds a threshold value on the output terminals, and, if so, indicating an islanding condition.

6. The method of claim 5, wherein the nth harmonic is the 5th harmonic, and the distinctive phase sequence is a positive phase sequence.

7. The method of claim 5, wherein the nth harmonic is the 7th harmonic, and the distinctive phase sequence is a negative phase sequence.

8. The method of claim 5, wherein the converter is a power-packet switching converter.
